(19) United States
(12) Patent Application Publication
(10) Pub. No.: US 2026/0315841 A1
(43) Pub. Date: Oct. 15, 2026

(54) Fire-Safety System

(71) Applicant: Jarrett Wyatt, Kingsport, TN (US)

(72) Inventor: Jarrett Wyatt, Kingsport, TN (US)

(21) Appl. No.: 19/639,806

(22) Filed: Apr. 6, 2026

Related U.S. Application Data
(60) Provisional application No. 63/784,354, filed on Apr. 7, 2025.

(51) Int. Cl. A62C 3/06; A62C 3/07; A62C 37/36

(52) U.S. Cl. CPC A62C 3/065; A62C 3/07; A62C 37/04

(57) ABSTRACT

A fire-safety system may cause a fire-extinguishing substance within a receptacle to move by design to inside a container containing a flammable or combustible material in response to a detected fire potential condition. In some embodiments, a vehicle fire-safety system may cause a fire-extinguishing substance within a receptacle to move by design to inside a fuel tank or a battery pack in response to a detected vehicle impact.

This patent application claims priority to U.S. Provisional Patent Application No. 63/784,354, filed Apr. 7, 2025, entitled VEHICLE FIRE-SAFETY AUGMENTER SYSTEM, which is incorporated herein by reference in its entirety.

### I. BACKGROUND

### A. Field of the Invention

The National Safety Council estimates motor vehicle deaths involving other motor vehicles increased over 40% from 2012 to 2022. In addition, the Centers for Disease Control (CDC) warns motor vehicle crashes are a public health concern not only in the United States, but around the world. In addition, motor vehicle crashes are a leading cause of death and claim over 100 lives daily.

In addition to the ramifications of motor vehicle crashes, response times for Emergency Medical Services (EMS) are not immediate and, therefore, also compound this long-felt need for greater motor vehicle safety. For instance, the American Medical Association surveyed over 1.2 million EMS encounters from 485 EMS agencies scattered throughout the United States. JAMA Surg. 2017 Jul. 19; 152(10):983-984. In sum, medical researchers discovered suburban and urban settings had 6-minute median response times (i.e., the interval between the 911 call receipt and the arrival of the initial EMS unit to the location of the reported emergency). In rural settings, the median time increased to 13 minutes (mean=14.5 minutes). Id.

With these statistics still showing an ongoing need for greater safety around motor vehicle crashes, the present disclosure provides a vehicle fire-safety system that causes a fire-extinguishing substance within a receptacle to move by design to inside a fuel tank or a battery pack in response to a detected vehicle impact.

This inventor also realized that this invention's application is not limited to motor vehicles. Thus, the present disclosure provides more broadly a fire-safety system that causes a fire-extinguishing substance within a receptacle to move by design to inside a container containing a flammable or combustible material in response to a detected fire potential condition.

### B. Description of Related Art

U.S. Pat. No. 5,767,766 (Kwun) proposes an apparatus and method for monitoring vehicular impacts using sensors at locations appropriate for sensing and measuring waves of stress in a vehicle caused by vehicular collisions. In addition, signals sensors are processed in a data processor, which analyzes the detected signals. U.S. Pat. No. 9,566,936 (Biller et al.) discloses an actuator composed of an elongate pyrotechnical element and a shape-variable wire that is subject to a change in length from ignition of the pyrotechnical element.

In addition, despite these advances in vehicular impact technology, there was still a long-felt need for greater safety advances. To wit, U.S. Pat. No. 10,717,450 (Sirous) states, “[f]ire safety in buses has been the focus of significant research in recent years but much improvement still remains, in particular related to fire prevention egress and safe egress.” Col. 1, ll. 36-39 (emphasis added). Furthermore, several practices of improving travel safety are listed, including ceramic fiber, Kaowool blankets, Cerachem blankets, Cerachrome blankets, and fire-resistant glass. See generally, cols. 2-3.

The application of extinguishing methods is one method for combatting fires. For instance, U.S. Pat. No. 11,180,253 (Seeley) proposed a fire-suppression system including interoperable vehicles providing a concerted effort for delivering fire-retardant on fires by robotic aircraft. It is known to supply a fire retardant on or around a fuel tank when a vehicle accident occurs. Examples of this idea are disclosed in U.S. Pat. Nos. 5,762,145, 5,934,379, U.S. Publication 2006/0231318 and German patent DE 102004013208.

Several fire-extinguishing substances are known. U.S. Pat. No. 3,633,675 (Biederman, Jr.) discloses a fire-retardant foam comprised of montmorillonite clay float ash and phosphate rock. This foam was created using water infused clay material in addition to float ash and fine-grain phosphate rock. Subsequently, the foam could be used to prevent fire damage to materials, such as those in buildings. However, with the advent of newer technologies, such as batteries in all electric vehicles (EV), plug-in hybrid vehicles (PHEV), and hybrid vehicles (HEV), there are ongoing concerns for thermal management. For instance, U.S. Patent Publication No. 2018/0223070 (O'Neil et al.), discloses a secondary battery back having improved thermal management for EVs, PHEVs, and HEVs. However, this only consists of material used in the thermal insulation thereby reducing the propagation of thermal runaway with battery packs.

However, none of the disclosures known to this inventor provide a vehicle fire-safety system that causes a fire-extinguishing substance within a receptacle to move by design to inside a fuel tank or a battery pack in response to a detected vehicle impact.

But this invention is not limited to applications with automotive vehicles. It also applies to other vehicles, such as planes and trains and applies to non-vehicular applications such as fuel storage tanks and battery storage areas. Thus, what is disclosed herein generally is a fire-safety system that causes a fire-extinguishing substance within a receptacle to move by design to inside a container containing a flammable or combustible material in response to a detected fire potential condition.

### II. SUMMARY

According to some embodiments of this invention, a fire-safety system may be used with a first container containing a flammable or combustible material. The fire-safety system may include: a first receptacle containing a fire-extinguishing substance; and a fire potential detection system that: (a) detects a fire potential condition; and (b) causes the fire-extinguishing substance to move from the first receptacle to inside the first container by design, to contact the flammable or combustible material within the first container in response to a detected fire potential condition.

According to some embodiments of this invention, a vehicle fire-safety system may be used with a first container supported to a vehicle and containing a flammable or combustible material. The vehicle fire-safety system may include: a first receptacle containing a fire-extinguishing substance; and a vehicle impact detection system that: (a) detects a vehicle impact; and (b) causes the fire-extinguishing substance to move from the first receptacle to inside the first container by design, to contact the flammable or combustible material within the first container in response to a detected vehicle impact.

According to some embodiments of this invention, the first receptacle is supported to the first container and/or is positioned within the first container.

According to some embodiments of this invention, the first container contains a fuel, and the first receptacle contains a fire-extinguishing substance designed to extinguish a fuel fire. According to other embodiments, the first container contains at least one battery, and the first receptacle contains a fire-extinguishing substance designed to extinguish a battery fire.

According to some embodiments of this invention, the fire-safety system may also be used with a second container containing a flammable or combustible material. In some embodiments, the fire potential detection system also causes the fire-extinguishing substance to move from the first receptacle to inside the second container by design, to contact the flammable or combustible material within the second container in response to the detected fire potential condition.

According to some embodiments of this invention, the fire-safety system may also be used with a second container containing a flammable or combustible material. In some embodiments, the fire-safety system further comprises a second receptacle containing a fire-extinguishing substance and the fire potential detection system causes the fire-extinguishing substance to move from the second receptacle to inside the second container by design, to contact the flammable or combustible material within the second container in response to the detected fire potential condition.

According to some embodiments of this invention, the first container has distinct first and second internal locations and the fire potential detection system causes the fire-extinguishing substance to move from the first receptacle: (a) to the first internal location inside the first container by design; and (b) to the second internal location inside the first container by design.

According to some embodiments of this invention, the first container has multiple internal locations and the fire potential detection system: (a) determines which of the multiple internal locations is/are most/more likely to cause a fire by thermal communication or electrical communication; and (b) causes the fire-extinguishing substance to move primarily to the internal location(s) determined to be most/more likely to cause a fire.

According to some embodiments of this invention, the fire potential detection system can be operated remotely. One of ordinary skill in the art would understand that this remote operation could include a remote using wireless signaling, electromagnetic waves, or radio waves; non-limiting examples of these include very law frequency (VLF), low frequency (LF), medium frequency (MF), high frequency (HF), very high frequency (VHF), ultra-high frequency (UHF), super high frequency (SHF), extremely high frequency (EHF), microwaves, infrared transmission, visible light communication, laser communication, Wi-Fi, cellular networks (2G, 3G, 4G, 5G, etc.), near field communication (NFC), radio frequency identification (RFID), vehicle-to-everything (V2X) communication, or another frequency used by one skilled in the art of emergency response.

A vehicle fire-safety augmenter system (VFSAS), also known as a fire-safety system or vehicle fire-safety system, reduces the risk of motor vehicle fires and explosions following a triggering event (e.g., motor vehicle collision, an airbag deployment, a vehicle monitoring systems registering an imminent crash via video data from a vehicle's camera or visual monitoring system). Unlike the over three-hundred-second wait verified by the American Medical Association review of over a million EMS encounters, the VFSAS provides something that is persistently lacking in the automotive industry: namely, a near-immediate solution to the multiple-minute EMS response following a motor vehicle crash or collision. Currently, multiple steps normally occur before first responders arrive, including the collision being reported from bystanders and witnesses, the determination of location, local traffic congestion, rush hour traffic. However, apart from airbags and supplemental restraint systems, there is not an onsite application fire-extinguishing substances from the impacted vehicle itself. This persistent need represents lives that are unnecessarily placed in jeopardy due to ongoing risk of fires and explosions following compromise of a vehicular fuel source, such as a fuel tank or hybrid battery.

To address this unmet need, the VFSAS comprises a (1) vehicle-impact sensor (e.g., such as those used in conjunction with an airbag deployment system, resulting in near instantaneous deployment following a predetermined impact threshold), (2) an actuator (e.g., a data processor capable of recognizing an electronic or mechanical signal) able to receive at least one signal from the vehicle-impact sensor via (3) at least one communication medium (e.g., such as a wire or wireless communication), (4) an onsite receptacle, (5) a channel (having ingress and egress ports) providing for passage of contents from the onsite receptacle to a site of possible motor-vehicle fire or explosion (such as a motor vehicle fuel source), and (6) at least one fire-extinguishing substance housed in the onsite receptacle.

The signals (e.g., propagated from the vehicle-impact sensor, actuator, channel to the ingress and egress ports) could be mechanical (such as on impact from or following a collision), electrical, digital, pneumatic, hydraulic, or any other mode used by a person of ordinary skill in the art to provide impetus for communication from sensors to actuators or data processors.

In addition, the fire-extinguishing substances, both in general and in the VFSAS, could include water, air pressurized water, water mist, film-forming foam (e.g., aqueous film-forming foam (AFFF) and film-forming fluoroprotein (FFFP)), phosphate-containing chemicals (e.g., monoammonium phosphate (MAP)), carbon dioxide (CO2), halon (e.g., bromochlorodifluoromethane (Halon 1211)), a sugar derivative (e.g., gluconic acid, galactonic acid, glycoaldiehyde, etc.). Beyond these illustrative fire-extinguishing substances, a person of ordinary skill in the art would understand these foregoing fire-extinguishing substances may be combined in sufficient concentrations for the lessening the risk of fires or explosions in the impact's setting, such as in or on gasoline-powered vehicles, diesel-powered vehicles, EVs, PHEVs, and HEVs.

Also, the VFSAS could use different dry or wet chemical types as a component to its fire-extinguishing substances, including: (1) ordinary dry chemical agents (e.g., sodium bicarbonate base, potassium bicarbonate base), (2) multipurpose dry chemical agents (e.g., ammonium phosphate base agent), (3) wet chemical agents (e.g., combinations of water with potassium acetate, potassium carbonate, potassium citrate, or a combination thereof), (4) trichloroisocyanuric acid (TCIA), (5) carbon dioxide (CO2), and (6) any combination of dry or wet chemicals used in fire-extinguishing or retarding substances. In addition, one of ordinary skill in the art would understand non-limiting examples of dry-powder agents (also considered fire-extinguishing substances, both in general and in the VFSAS) could include sodium chloride, graphite-based products, graphene-based products, copper-based products, or combinations thereof.

In addition, the VFSAS fire-extinguishing substances could be mixed or combined with a propellant to facilitate or accelerate transportation to the desired location, such as fuel tank or battery. In addition, the channel, ingress port, and/or egress port could be fitted with different nozzles or applicators to provide for adequate propelling and distribution of the fire-extinguishing substances.

In an illustrative embodiment, the fire-safety system has the intrinsic benefit of reducing the median response time for EMS and other first responder (such as fire department) encounters by having an onsite supply of a fire-extinguishing substance. In addition, the fire-safety system would also be less dependent on conduits, pipes, or other channels for operatively delivering a fire-extinguishing substance because such substance could be present in the container containing a flammable or combustible material, such as a fuel tank or battery. The prior art has a dependence on conduits, pipes, and other channels; however, this dependence can be detrimental in vehicle crashes where the frame or other part of the vehicle is crunched. For example, the crunch could sever, splice, crimp, or otherwise affect the ability of a fire-extinguishing substance to be deployed in or near a fuel source.

Another benefit in the present disclosure is the elimination of the driver/passenger/user of a vehicle or device having to initiate contact EMS responders following a fire potential condition. In contrast, the present fire-safety system uses a fire potential detection system to detect a fire potential condition and cause a fire-extinguishing substance to be strategically deployed to the inside of a container. This benefit is intrinsic, as during a crash, a driver/passenger/user of a vehicle or device might have slower or no response times, be rendered unconscious, or disoriented.

In addition, driver/passenger/user devices, such as mobile phones, might not be readily available following a crash to contact EMS and fire department aid. In addition, as the fire-safety system is designed to deliver both a predetermined and sufficient amount of fire-extinguishing substance based on the fire potential condition. For instance, gasoline fires respond differently to certain fire-extinguishing substances than battery/electrical fires. To wit, the fire-safety system would already have a more effective fire-extinguishing substance than an ad hoc decision when the crash occurs.

One of ordinary skill in the art would understand that the fire potential detection system could detect a temperature capable of combusting the flammable or combustible material (including, but not be limited to: gasoline, ethanol, diesel, propane, other refined hydrocarbons, and other petroleum-derived solids, liquids, or gases) used in the first container.

Furthermore, one of ordinary skill in the art would understand the detected fire potential condition could include, but not be limited to: an autoignition temperature, a flammable (explosive) range, a flash point, a fire/combustion point, an ignition point, an actual fire, a sensed crash, lightening, sparking from a battery or other electrical source, a pressure change, and an interruption or disruption in electricity or current in an EV, PHEV, or HEV, etc. Example of autoignition would be (1) for gasoline, approximately 236 degrees Celsius, and (2) for ethanol approximately 363 degrees Celsius. However, one of ordinary skill in the art would appreciate the fuel being used and the corresponding dangers associated with conditions attendant to impairment of manufacturer recommendations.

One of ordinary skill in the art would understand that “by design” implies an exclusion of inadvertent operation. In contrast, the fire potential detection system is engineered as opposed to unintentional-to cause flowing of a fire extinguishing substance from the first receptacle. For example, during a vehicle crash, it is conceivable that the fuel tank might split or crack, thereby allowing a fire-extinguishing substance to be released at an uncontrolled or undetermined manner. However, that flow would, among other things, be inadvertent, not intentional, and not caused by a fire potential detection system.

The figures show exemplary embodiments of a VFSAS; however, a person of ordinary skill in the art would understand the VFSAS could have more than one vehicle-impact sensor, more than one communication medium, more than one actuator, more than one onsite receptacle able to urge contents from it, more than one channel, more than one egress port, more than one ingress port, and more than one fire-extinguishing substance housed in the onsite receptacle.

In addition, one of ordinary skill in the art would understand that depending on the size of the fuel source or tank, different fire-extinguishing substances and substances or combinations thereof would be required for the plethora of makes and models of motorized vehicles in the global industry. Each of these makes and models would necessitate different amounts of fire-extinguishing substances and different nonobvious configurations illustrated in this disclosure.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a schematic representation of embodiments of this invention.

FIG. 2 is a schematic representation similar to what is shown in FIG. 1 but with the receptacle supported to the container.

FIG. 3 is a schematic representation similar to what is shown in FIG. 1 but with the receptacle positioned within the container.

FIG. 4 is a schematic representation showing the use of two containers and one receptacle.

FIG. 5 is a schematic representation showing the use of two containers and two receptacles.

FIG. 6 is a schematic representation showing the use of multiple openings or nozzles within a container.

FIG. 7 shows embodiments of how a fire potential detection system may be operated.

FIG. 8 is a side view of a vehicle fire-safety system in the form of a vehicle fire-safety augmenter system (VFSAS).

FIG. 9 is a side view of a VFSAS according to other embodiments of this invention.

FIG. 10 is a side view of a VFSAS according to other embodiments of this invention with the receptacle positioned within the container.

FIG. 11 is a side view of a VFSAS according to other embodiments of this invention with the receptacle positioned within the container and the actuator in a closed position.

FIG. 12 is a side view of a VFSAS similar to that shown in FIG. 11 but with the actuator in an open position.

FIG. 13 is a side view of a VFSAS showing the receptacle touching the outer surface of the fuel source.

### IV. DETAILED DESCRIPTION

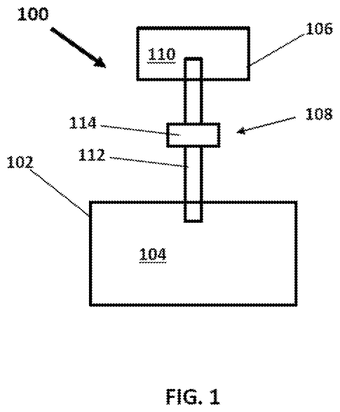

Referring now to the drawings wherein the showings are for purposes of illustrating embodiments of the invention only and not for purposes of limiting the same, and wherein like reference numerals are understood to refer to like components, FIG. 1 is a schematic representation of this invention according to some embodiments. FIG. 1 shows a fire-safety system 100 that may be used with a container 102 containing a flammable or combustible material 104. The flammable or combustible material 104 can be any material that can be a fire hazard. Non-limiting examples of flammable or combustible materials that can be used with this invention are discussed below. The fire-safety system 100 may include a receptacle 106 and a fire potential detection system 108. The receptacle 106 may contain a fire-extinguishing substance 110. The fire-extinguishing substance 110 can be any substance that can be used to extinguish a fire. Non-limiting examples of fire-extinguishing substances that can be used with this invention are discussed below.

With continuing reference to FIG. 1, the fire potential detection system 108 may be operated to detect a fire potential condition and cause the fire-extinguishing substance 110 to move (in any manner, such as to flow or otherwise pass) from the receptacle 106 to inside the container 102 by design. The phrase “by design” means, in this specification and patent claims, that the fire potential detection system 108 causes the fire-extinguishing substance 110 to move from the receptacle 106 to inside the container 102 purposefully and intentionally. Once inside the container 102, the fire-extinguishing substance 110 will contact the flammable or combustible material 104 to thereby extinguish a fire, diminish the chance of a fire or otherwise reduce negative consequences of a potential fire in and around the container 102.

With continuing reference to FIG. 1, the operation of the fire potential detection system 108 may be any chosen with the sound judgment of a person of skill in the art. In some non-limiting embodiments, the fire potential detection system 108 may include a channel 112 that interconnects the receptacle 106 to the inside of the container 102 and a control valve 114 that can be opened in response to a detected fire potential condition. The fire potential condition that is detected can be any chosen with the sound judgment of a person of skill in the art. Non-limiting examples of fire potential conditions that can detected with this invention are discussed below.

Still referring to FIG. 1, in some embodiments, the fire-extinguishing substance 110 in the receptacle 106 is chosen to match (that is, to best treat the fire potential of) the flammable or combustible material 104 within the container 102. In one embodiment, for example, the container 102 contains a fuel 104 and the receptacle 106 contains a fire-extinguishing substance 110 designed to extinguish a fuel fire. In another embodiment, the container 102 contains at least one battery 104 and the receptacle 106 contains a fire-extinguishing substance 110 designed to extinguish a battery fire.

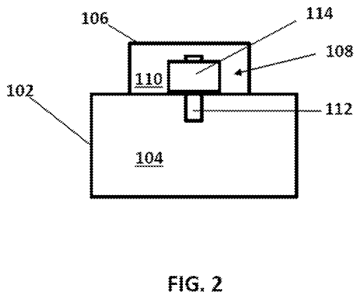

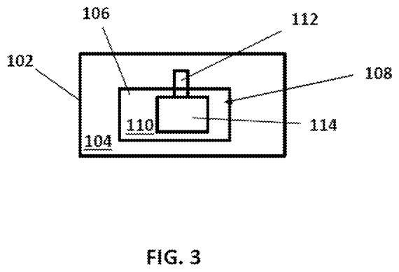

FIG. 2 shows an embodiment similar to that shown in FIG. 1 but with the receptacle 106 supported to the container 102. This may minimize the support structure required to support the receptacle 100 and, in some embodiments, may also minimize the support structure required to support the fire potential detection system 108. FIG. 3 shows an embodiment similar to that shown in FIG. 1 but with the receptacle 106 positioned within the container 102. This may protect the receptacle 106 and/or the fire potential detection system 108 from interference.

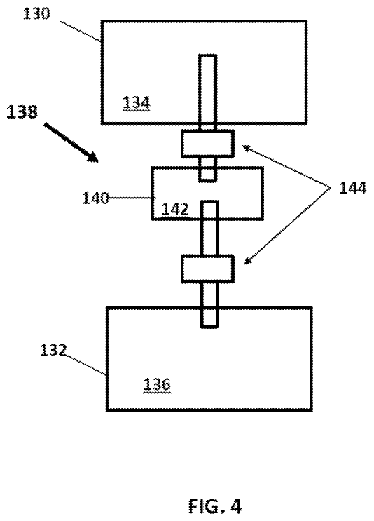

FIG. 4 shows embodiments where first and second containers 130, 132 each containing a flammable or combustible material 134, 136, respectively, are used. A fire-safety system 138 may include a receptacle 140 containing a fire-extinguishing substance 142 and a fire potential detection system 144. Upon detection of a fire potential condition, the fire potential detection system 144 may, in some embodiments, cause the fire-extinguishing substance 142 to move simultaneously from the receptacle 140 into both the first and second containers 130, 132. In other embodiments, upon detection of a fire potential condition, the fire potential detection system 144 may cause the fire-extinguishing substance 142 to move from the receptacle 140 only into one of the first and second containers 130, 132. In yet other embodiments, upon detection of a fire potential condition, the fire potential detection system 144 may cause the fire-extinguishing substance 142 to move from the receptacle 140 only into one of the first and second containers 130, 132 for a determined time period and then into the other of the first and second containers 130, 132 for a determined time period. In still other embodiments, upon detection of a fire potential condition, the fire potential detection system 144 may cause the fire-extinguishing substance 142 to move from the receptacle 140 into one of the first and second containers 130, 132 at a determined quantity per time and into the other of the first and second containers 130, 132 at a different determined quantity per time. Determining which of these variations to use in a particular application, as well as other variations, would be understood and applied by a person of skill in the art.

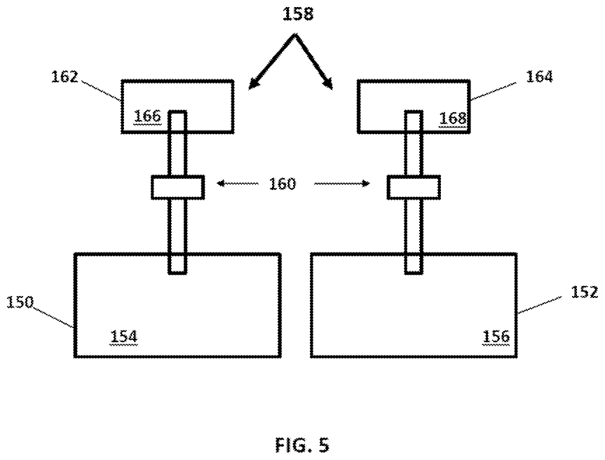

FIG. 5 shows embodiments where first and second containers 150, 152 each containing a flammable or combustible material 154, 156, respectively, are used and a fire-safety system 158 including a fire potential detection system 160 and first and second receptacles 162, 164 each containing a fire-extinguishing substance 166, 168 is used. Upon detection of a fire potential condition, the fire potential detection system 160 may cause the fire-extinguishing substance 166 to move from the first receptacle 162 into the first container 150 and may simultaneously, or at different times and at different times quantity per time rates, cause the fire-extinguishing substance 168 to move from the second receptacle 164 into the second container 152. In some embodiments, the fire-extinguishing substance in the receptacle is chosen to match (that is, to best treat the fire potential of) the flammable or combustible material within the corresponding container. In one embodiment, for example, the first container 150 contains a fuel 154 and the first receptacle 162 contains a fire-extinguishing substance 166 designed to extinguish a fuel fire and the second container 152 contains at least one battery 156 and the second receptacle 164 contains a fire-extinguishing substance 168 designed to extinguish a battery fire.

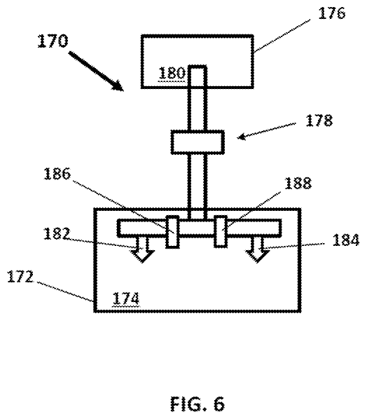

FIG. 6 shows embodiments similar to that shown in FIG. 1. A fire-safety system 170 may be used with a container 172 containing a flammable or combustible material 174. The fire-safety system 170 may include a receptacle 176 and a fire potential detection system 178. The receptacle 176 may contain a fire-extinguishing substance 180. These embodiments differ from the embodiments shown in FIG. 1 in that the fire-extinguishing substance 180 can be moved to more than one location inside the container 172. In some embodiments, the fire potential detection system 178 includes multiple openings or nozzles 182, 184 that distribute the fire-extinguishing substance 180 at discreet locations inside the container 172. In some embodiments, the fire potential detection system 178 also includes multiple control valves 186, 188, or the like, that are used to control which openings or nozzles 182, 184 receive the fire-extinguishing substance 180 as well as much and how often the fire-extinguishing substance 180 is provided to each opening or nozzle 182, 184. This provides the advantage in some embodiments that when the fire potential detection system 178 determines which of the internal locations is/are most/more likely to cause a fire (or be subject to a fire), the fire potential detection system 178 causes the fire-extinguishing substance 180 to move primarily (or exclusively) to the internal location(s) determined to be most/more likely to cause a fire (or be subject to a fire).

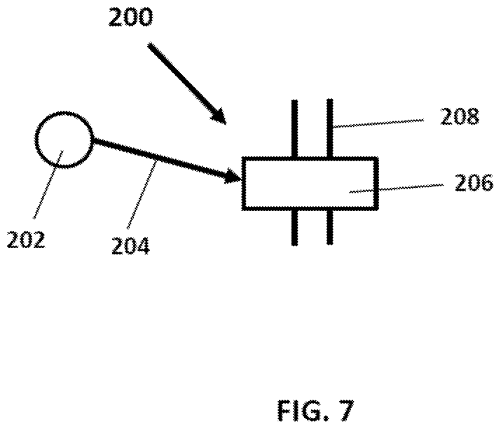

FIG. 7 shows embodiments of how a fire potential detection system 200 may be operated. In some embodiments, a sensor 202 senses a determined fire potential condition and that sensed fire potential condition is what serves as the detection. The sensor 202 may then send a signal through a sensor communication medium 204 to a control valve 206, or the like, positioned in a channel 208 that connects a receptacle containing a fire-extinguishing substance (not shown here, but shown above) to a container containing a flammable or combustible material (not shown here, but shown above). The determined fire potential condition and thus the corresponding sensor used, can be any chosen by the sound judgement of a person of skill in the art. It is contemplated that the fire potential detection system 200 may be operated automatically, in immediate reaction to the determined fire potential condition. It is also contemplated that the fire potential detection system 200 may be operated remotely. This may be required, for example, if the automatic operation failed and may be used, for example, by professional fire fighters.

Applications for the inventive fire-safety systems disclosed are nearly limitless. But this inventor has considered a particular application-for vehicles. Specific embodiments for this application will be provided below. But it should be noted that all that has been disclosed so far could be applied to a vehicle. A vehicle fire-safety system is a type of fire-safety system; a vehicle impact detection system is a type of fire potential detection system and a detected vehicle impact is a type of a detected fire potential condition.

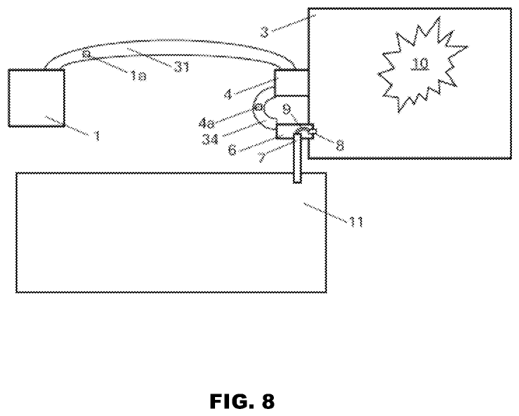

In FIG. 8, a vehicle fire-safety augmenter system (VFSAS) comprises a vehicle-impact sensor 1 placed on or in any vehicle (such as ones used in an airbag deployment system for motor vehicles) that can urge at least one vehicle-impact sensor signal 1a following a triggering event (e.g., a motor vehicle collision, etc.) via a vehicle-impact sensor communication medium 31 towards the actuator 4. The actuator 4 is able to receive at least one signal 1a from the vehicle-impact sensor 1.

The actuator 4 is operably connected to the onsite receptacle 3 via an actuator communication medium 34, which can receive at least one actuator signal 4a. The actuator 4 can control the onsite receptacle's 3 selective urging of at least one fire-extinguishing substance 10 towards a vehicle fuel source 11.

Specifically, the onsite receptacle 3 is able to urge at least one fire-extinguishing substance 10 towards the vehicle fuel source 11 via a channel 6; the channel 6 is comprised of an ingress port 8 operably connected to an egress port 7 via an elongate tube 9. However, one of ordinary skill in the art would recognize that operable connection from the ingress port 8 to the egress port 7 could occur without the elongate tube 9 but rather by direct connection of the ingress port 8 and egress port 7.

Decreasing the time needed for application of fire-extinguishing substances to a fuel source, such as fuel tank increases motor vehicle safety by minimizing the risk of a spark, flame, or heat creating a fire or explosion with the vehicle fuel source 11. In addition, one of ordinary skill in the art would understand that the vehicle fuel source 11 could include a fuel tank, a fuel line, a fuel transport line, or other connections between a fuel tank and the engine. For example, by allowing at least one fire-extinguishing substance 10 to be placed in and near the vehicle fuel source 11 following a vehicle impact, the risk of fire and subsequent explosions can be reduced, thereby increasing safety and risk of burns or death.

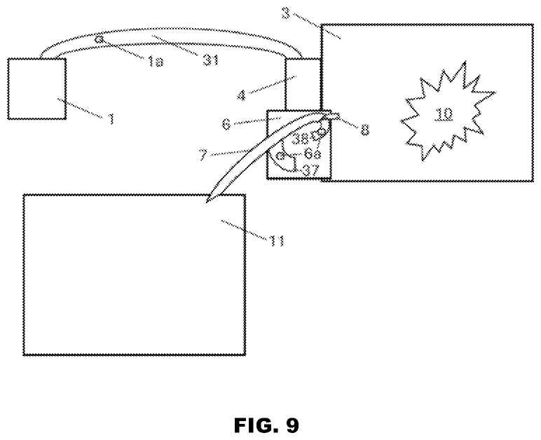

In an alternative embodiment, as illustrated in FIG. 9, the vehicle-impact sensor 1 is operably connected to the actuator 4 via the vehicle-impact sensor communication medium 31, whereby the vehicle-impact sensor communication medium 31 can carry at least one vehicle-impact sensor signal 1a. In this illustrative embodiment, the actuator 4 is operably adjacent to the 7 channel 6 without the actuator communication medium 34. The channel 6 comprises an ingress port 8 operably connected to the egress port 7, thereby allowing the onsite receptacle 3 to selectively urge the at least one fire-extinguishing substance 10 to the vehicle fuel source 11 following activation from the actuator 4. The channel 6 is able to selectively open and close both the ingress port 8 and the egress port 7 via communication with an ingress communication medium 38 and an egress communication medium 37, respectively. The selective opening and closing of the ingress port 8, the egress port 7, or both ports 7, 8 occurs by the channel 6 sending a channel signal 6a from the channel 6 to the ports 7, 8 via the egress communication medium 37 and the ingress communication medium 38. The selective opening and closing allow for a more controlled application of at least one fire-extinguishing substance 10.

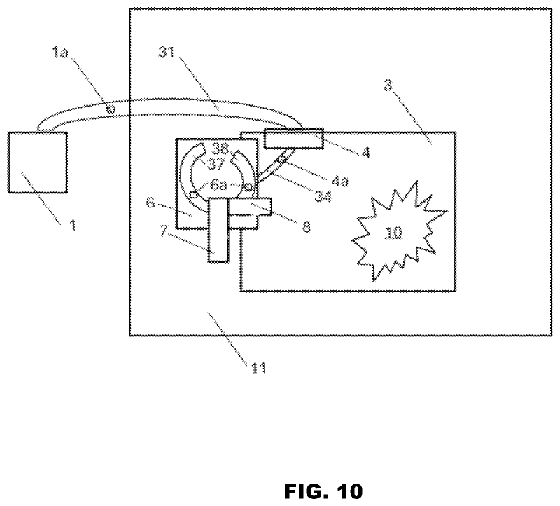

In yet another exemplary embodiment, as illustrated in FIG. 10, the vehicle-impact sensor 1 is operably connected to the actuator 4 via the vehicle-impact sensor communication medium Page of 8 14 31. The vehicle-impact sensor 1, upon activation (such as airbag deployment, imminent crash recognition via video feed, etc.) can urge at least one vehicle-impact sensor signal 1a from the vehicle-impact sensor 1. The vehicle-impact sensor communication medium 31 is able to urge at least one vehicle-impact sensor signal 1a towards the actuator 4. In FIG. 10, the actuator 4 is placed inside the onsite receptacle 3, which contains at least one fire-extinguishing substance 10. The actuator 4 is operably connected to the channel 6 via the actuator communication medium 34. The actuator communication medium 34 is able to urge at least one actuator signal 4a from the actuator 4 towards the channel 6. Following the actuator signal 4a, the channel 6 selectively controls the urging of the at least one fire-extinguishing substance 10 from the onsite receptacle 3 to the vehicle fuel source 11 via the use of an ingress port 8 and an egress port 7. Both ports are able to be selectively opened by the channel 6 via a channel signal 6a via the ingress communication medium 38 and the egress communication medium 37. The egress and ingress communication mediums 37, 38 are operatively connected to the channel 6, and work in tandem with the ingress port 8 and egress port 7 to transport at least one fire-extinguishing substance 10. In addition, using either the channel 6, the ingress port 8, or the egress port 7, at least one fire-extinguishing substance 10 can be selectively urged from the onsite receptacle 3 into or onto the vehicle fuel source 11. The selective urging allows for a more controlled application of the fire-extinguishing substance 10.

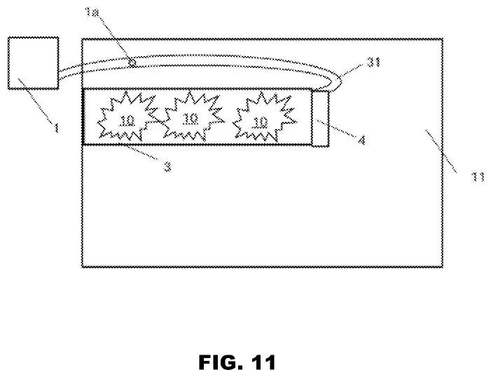

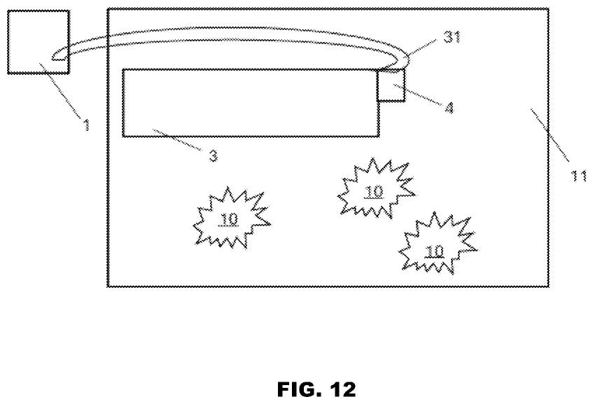

In FIG. 11, another exemplary embodiment, the vehicle-impact sensor 1 sends a vehicle-impact sensor signal 1a via a vehicle-impact sensor communication medium 31 towards an actuator 4. The actuator 4 is then able to collapse or break from its closed state (FIG. 11) to an open state, as shown in FIG. 12. Continuing with FIG. 11, the onsite receptacle 3 contains at least one fire-extinguishing substance 10, which-by design-is capable of being released from the onsite receptacle 3 into or onto the vehicle fuel source 11, thereby reducing the risk of vehicle fire or explosion.

A person of ordinary skill in the art would understand that multiple onsite receptacles 3 could be used. In addition, one of ordinary skill in the art would understand the onsite receptacle 3 may be on the right, left, above, below, attached to, or operably attached to the actuator 4.

In FIG. 12, the open state of the actuator 4 is shown thereby allowing the fire-extinguishing substance 10 to fall into or onto the vehicle fuel source 11.

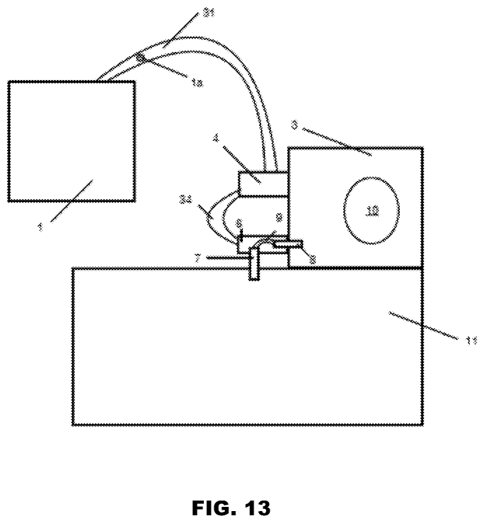

In FIG. 13, the VFSAS comprises the vehicle-impact sensor 1 placed on or in any vehicle (such as ones used in an airbag deployment system for motor vehicles) can urge at least one vehicle-impact sensor signal 1a following a triggering event (e.g., a motor vehicle collision, etc.) via a vehicle-impact sensor communication medium 31 towards the actuator 4. The actuator 4 is able to receive at least one signal 1a from the vehicle-impact sensor 1.

The actuator 4 is operably connected to the onsite receptacle 3 via an actuator communication medium 34, which can receive at least one actuator signal 4a. The onsite receptacle 3 is contacts at least a portion of the outer surface of a vehicle fuel source 11. One of ordinary skill in the art would appreciate that the contact by onsite receptacle 3 could include support by at least a portion of the outer surface of a vehicle fuel source 11. The actuator 4 can control the onsite receptacle's 3 selective urging of at least one fire-extinguishing substance 10 towards the vehicle fuel source 11.

Specifically, the onsite receptacle 3 is able to urge at least one fire-extinguishing substance 10 towards the vehicle fuel source 11 via a channel 6; the channel 6 is comprised of an ingress port 8 operably connected to an egress port 7 via an elongate tube 9. However, one of ordinary skill in the art would recognize that operable connection from the ingress port 8 to the egress port 7 could occur without the elongate tube 9 but rather by direct connection of the ingress port 8 and egress port 7.

In FIGS. 8-11, a person of ordinary skill in the art would understand the vehicle fuel source 11 would not be limited to gasoline or diesel fuel tanks but would also represent other types of energy receptacles, reservoirs, sources, or containers able to operatively hold electrical power, such as car batteries and hybrid car batteries for EVs, PHEVs, and HEVs.

One of ordinary skill in the art would understand non-limiting of flammable or combustible materials would include: gasoline, diesel fuel, kerosene, jet fuel, heating oil, petroleum-produced products, bitumen, butane, liquified natural gas, liquified petroleum gas, propane, ethanol, coal, petrochemicals (including aliphatic, aromatic, and naphthenic organic chemicals), petrochemical feedstocks (including, generally, olefins (such as: ethylene, propylene, and butadiene), aromatics (such as: toluene, xylene, and naphthalene), synthesis gas, and inorganics), carbon black, and inorganic materials (including sulfur and ammonia), benzene, ethyl alcohol, wood, paper, cloth, rubber, plastic, furniture, grease,

One of ordinary skill in the art would understand non-limiting types of batteries would include: lithium iron phosphate (LFP), lithium cobalt oxide (LCO), lithium manganese oxide (LMO), lithium titanate, nickel manganese cobalt (NMC), nickel cobalt aluminum (NCA), solid-state batteries, lithium-ion (Li-Ion), nickel-metal hydride (NiMH), lead-acid, ultracapacitors, and sodium-ion. Furthermore, one of ordinary skill in the art would understand that batteries in EVs, PHEVs, and HEVs would include traction batteries and auxiliary batteries.

One of ordinary skill in the art would understand non-limiting types of fire-extinguishing substances could include water, film-forming foam (such as aqueous film-forming foam (AFFF) and film-forming fluoroprotein (FFFP)), phosphate-containing chemicals (such as monoammonium phosphate), carbon dioxide (CO2), halon (such as bromochlorodifluoromethane (Halon 1211)), or a sugar derivative (such as gluconic acid, galactonic acid, glycoaldiehyde, etc.). In addition, one of ordinary skill in the art would appreciate the types of fire extinguishers A (ordinary combustibles), B (flammable liquids), C (flammable gases), D (metal fires, such as from magnesium, lithium, titanium, sodium, potassium, and aluminum dust), E (electrical equipment), and K/F (kitchen & cooking oil fires). Beyond these illustrative fire-extinguishing substances, a person of ordinary skill in the art would understand these foregoing fire-extinguishing substances may be combined in sufficient concentrations and in optimal combinations for risk reduction or elimination of fires or explosions in or on gasoline-powered vehicles, diesel-powered vehicles, EVs, PHEVs, and HEVs, electric bikes, electric scooters, electric carts, boats, ships, planes, jets, other aircraft, spacecraft, rockets, missiles, batteries, electronic devices (such as phones, computers, laptops, televisions, monitors, etc.), fuel storage containers, fuel tanks (such as propane tanks, gasoline cans, etc.), power stations, substations, data centers, kitchens, and appliances (such as refrigerators, ovens, stoves, microwaves, etc.), deep fryers, air fryers, and furniture.

One or ordinary skill in the art would understand non-limiting types of fire potential conditions would include temperature changes (such as an autoignition temperature, a flammable (explosive) range, a flash point, a fire/combustion point, an ignition point, an actual fire), a sensed crash, an impact force, crash energy, a collision dynamic, a threshold collision duration, a threshold sensed energy dissipation via absorption by safety systems, a threshold sensed G-Force, lightening, sparking from a battery or other electrical source, a pressure change, and an interruption or disruption in electricity or current in an EV, PHEV, or HEV. Furthermore, one or ordinary skill in the art would appreciate that the fire potential condition would be affected, and accordingly engineered to account for mass, impact speed, collision duration, and collision type, and collision type (such as direction and location of impact).

While the apparatus, system, and method have been described with reference to various embodiments, those skilled in the art will understand that various changes may be made and equivalents may be substituted for elements thereof without departing from the scope and essence of the disclosure. In addition, many modifications may be made to adapt a particular situation or material in accordance with the teachings of the disclosure without departing from the essential scope thereof. Therefore, it is intended that the disclosure not be limited to the particular embodiments disclosed, but that the disclosure will include all embodiments falling within the scope of the appended claims. In this application all units are in the metric system and all amounts and percentages are by weight, unless otherwise expressly indicated. Also, all citations referred to herein are expressly incorporated herein by reference.

Having thus described the invention, it is now claimed:

I/We claim:

1. A fire-safety system for use with a first container containing a flammable or combustible material, the fire-safety system comprising:
a first receptacle containing a fire-extinguishing substance; and
a fire potential detection system that:
a) detects a fire potential condition; and
b) causes the fire-extinguishing substance to move from the first receptacle to inside the first container by design, to contact the flammable or combustible material within the first container in response to a detected fire potential condition.

2. The fire-safety system of claim 1 wherein:
the first receptacle is supported to the first container.

3. The fire-safety system of claim 1 wherein:
the first receptacle is positioned within the first container.

4. The fire-safety system of claim 1 wherein:
the first container contains a fuel; and
the first receptacle contains a fire-extinguishing substance designed to extinguish a fuel fire.

5. The fire-safety system of claim 1 wherein:
the first container contains at least one battery; and
the first receptacle contains a fire-extinguishing substance designed to extinguish a battery fire.

6. The fire-safety system of claim 1 for use with a second container containing a flammable or combustible material, wherein:
the fire potential detection system causes the fire-extinguishing substance to move from the first receptacle to inside the second container by design, to contact the flammable or combustible material within the second container in response to the detected fire potential condition.

7. The fire-safety system of claim 1 for use with a second container containing a flammable or combustible material, wherein:
the fire-safety system further comprises a second receptacle containing a fire-extinguishing substance; and
the fire potential detection system causes the fire-extinguishing substance to move from the second receptacle to inside the second container by design, to contact the flammable or combustible material within the second container in response to the detected fire potential condition.

8. The fire-safety system of claim 7 wherein:
the first container contains a fuel;
the second container contains at least one battery;
the first receptacle contains a fire-extinguishing substance designed to extinguish a fuel fire; and
the second receptacle contains a fire-extinguishing substance designed to extinguish a battery fire.

9. The fire-safety system of claim 1 wherein:
the first container has distinct first and second internal locations; and
the fire potential detection system causes the fire-extinguishing substance to move from the first receptacle:
a) to the first internal location inside the first container by design; and
b) to the second internal location inside the first container by design.

10. The fire-safety system of claim 1 wherein:
the first container has multiple internal locations; and
the fire potential detection system:
a) determines which of the multiple internal locations is/are most/more likely to cause a fire by thermal communication or electrical communication; and
b) causes the fire-extinguishing substance to move primarily to the internal location(s) determined to be most/more likely to cause a fire.

11. The fire-safety system of claim 1 wherein:
the fire potential detection system can be operated remotely.

12. A vehicle fire-safety system for use with a first container supported to a vehicle and containing a flammable or combustible material, the vehicle fire-safety system comprising:
a first receptacle containing a fire-extinguishing substance; and
a vehicle impact detection system that:
a) detects a vehicle impact; and
b) causes the fire-extinguishing substance to move from the first receptacle to inside the first container by design, to contact the flammable or combustible material within the first container in response to a detected vehicle impact.

13. The vehicle fire-safety system of claim 12 wherein:
the first receptacle is positioned within the first container.

14. The vehicle fire-safety system of claim 12 wherein:
the first container contains a fuel; and
the first receptacle contains a fire-extinguishing substance designed to extinguish a fuel fire.

15. The vehicle fire-safety system of claim 12 wherein:
the first container contains at least one battery; and
the first receptacle contains a fire-extinguishing substance designed to extinguish a battery fire.

16. The vehicle fire-safety system of claim 12 for use with a second container supported to the vehicle and containing a flammable or combustible material, wherein:
the vehicle impact detection system causes the fire-extinguishing substance to move from the first receptacle to inside the second container by design, to contact the flammable or combustible material within the second container in response to the detected vehicle impact.

17. The vehicle fire-safety system of claim 12 for use with a second container supported to the vehicle and containing a flammable or combustible material, wherein:
the vehicle fire-safety system further comprises a second receptacle containing a fire-extinguishing substance; and
the vehicle impact detection system causes the fire-extinguishing substance to move from the second receptacle to inside the second container by design, to contact the flammable or combustible material within the second container in response to the detected vehicle impact.

18. The vehicle fire-safety system of claim 17 wherein:
the first vehicle container contains a fuel;
the second vehicle container contains at least one battery;
the first receptacle contains a fire-extinguishing substance designed to extinguish a fuel fire; and
the second receptacle contains a fire-extinguishing substance designed to extinguish a battery fire.

19. The vehicle fire-safety system of claim 12 wherein:
the first vehicle container has distinct first and second internal locations; and
the vehicle impact detection system causes the fire-extinguishing substance to move from the first receptacle:
a) to the first internal location inside the first container by design; and
b) to the second internal location inside the first container by design.

20. The vehicle fire-safety system of claim 12 wherein:
the vehicle impact detection system can be operated remotely.
